(19) United States
(12) Patent Application Publication
(10) Pub. No.: US 2010/0259155 A1
(43) Pub. Date: Oct. 14, 2010

(54) ELECTRON BEAM APPARATUS AND IMAGE DISPLAYING APPARATUS

(75) Inventors: Taro Hiroike, Yamato-shi (JP); Yohei Hashizume, Machida-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/721,299

(22) Filed: Mar. 10, 2010

(30) Foreign Application Priority Data
Apr. 9, 2009 (JP) 2009-094716

(51) Int. Cl. H01J 29/46

(52) U.S. Cl. 313/452

(57) ABSTRACT

An electron beam apparatus of which the electron emission efficiency is high and in which capacitance between a gate and a cathode is small is provided. In the electron beam apparatus which is equipped with the gate and the cathode respectively formed on the side surface of an insulating member and an anode arranged on an elongation of a Z direction, the gate and the cathode are shifted from each other in a Y direction and then arranged so that orthogonal projection of the gate to the anode and orthogonal projection of the cathode to the anode do not overlap each other.

### BACKGROUND OF THE INVENTION

1. Field of the Invention

The present invention relates to an electron beam apparatus, which is equipped with an electron-emitting device of emitting electrons, to be used in a flat panel display, and to an image displaying apparatus in which the electron beam apparatus is used.

2. Description of the Related Art

Conventionally, there is known an electron beam apparatus which is equipped with an electron-emitting device in which a cathode and a gate are arranged closely and an anode which is used to accelerate electrons emitted from the cathode. In the relevant electron beam apparatus, a light-emitting member is arranged behind the anode, high voltage is applied between the cathode and the gate to emit the electrons from the cathode, and the emitted electrons are collided against the anode, whereby light is emitted from the light-emitting member. Incidentally, Japanese Patent Application Laid-Open No. 2001-167693 discloses an electron-emitting device which achieves high electron emission efficiency by a simple structure, and an image displaying apparatus which is equipped with the relevant electron-emitting device. In the relevant electron-emitting device, a recessed portion is provided on an insulating surface of a substrate, and a cathode and a gate are formed so that the recessed portion is located between the cathode and the gate, whereby electrons can be emitted from the cathode.

In the image displaying apparatus in which the above-described electron beam apparatus is used, it is desired to perform driving at lower driving voltage so as to reduce power consumption and achieve a high contrast ratio. Here, it is necessary to shorten an interval between the cathode and the gate so as to obtain field intensity which is necessary for electron emission at low driving voltage. However, it has been known that, if the distance between the gate and the cathode is shortened, a provability (i.e., electron emission efficiency) that the electrons emitted from the cathode reach the anode is lowered because, for example, they collide against the gate. Further, if the interval between the gate and the cathode is shortened, capacitance at an electron-emission portion increases. Thus, various problems such as rounding of a driving waveshape, occurrence of a cross talk, an increase of power consumption due to an increase of charging/discharging currents occur at the same time.

### SUMMARY OF THE INVENTION

An object of the present invention is to constitute an electron beam apparatus which has high electron emission efficiency and in which capacitance between a gate and a cathode is small, and to provide an image displaying apparatus of which the power consumption is low and which can display a high-contrast image, by using the relevant electron beam apparatus.

According to a first aspect of the present invention, there is provided an electron beam apparatus which is characterized by comprising: an insulating member which has a surface being in parallel with a first direction and a second direction orthogonal to the first direction; at least one rectangle-shaped cathode which is positioned on the surface of the insulating member and has an end side being in parallel with the first direction; an anode which is positioned on an elongation in the second direction and arranged to be opposite to the end side of the cathode being in parallel with the first direction; and at least one rectangle-shaped gate which is positioned on the surface of the insulating member and between the anode and the cathode, and has an end side being in parallel with the first direction, wherein orthogonal projection of the gate to the anode does not overlap orthogonal projection of the cathode to the anode.

According to a second aspect of the present invention, there is provided an image displaying apparatus which is characterized by comprising: an electron beam apparatus according to the first aspect of the present invention; and a light-emitting member which is laminated and positioned on the anode.

In the electron beam apparatus according to the present invention, since the gate and the cathode are constituted in a specific arrangement, electron emission efficiency improves, and at the same time capacitance decreases. For this reason, in the image displaying apparatus of the present invention in which the relevant electron beam apparatus is used, power consumption decreases, and at the same time a high contrast ratio can be achieved.

Further features of the present invention will become apparent from the following description of exemplary embodiments with reference to the attached drawings.

### BRIEF DESCRIPTION OF THE DRAWINGS

FIGS. 1A, 1B and 1C are schematic views illustrating an electron-emitting device of an electron beam apparatus according to an embodiment of the present invention.

FIG. 2 is a schematic view of the electron beam apparatus according to an embodiment of the present invention.

FIG. 3 is a partial enlarged view of a gate and a cathode of the electron-emitting device illustrated in FIGS. 1A, 1B and 1C.

FIGS. 4A and 4B are schematic views illustrating scattering of electrons at the gate of the electron-emitting device according to the present invention.

FIGS. 5A, 5B, 5C, 5D and 5E are schematic views illustrating arrangement examples of gates and cathodes of the electron-emitting devices according to the present invention.

FIGS. 6A and 6B are schematic views illustrating the shapes of an insulating member of the electron-emitting device according to the present invention.

FIGS. 7A, 7B and 7C are schematic views illustrating an electron-emitting device of an electron beam apparatus according to another embodiment of the present invention.

FIGS. 8A, 8B and 8C are schematic views illustrating a manufacturing process of the electron-emitting device illustrated in FIGS. 7A, 7B and 7C.

FIG. 9 is a schematic view illustrating the constitution of an image displaying apparatus according to an embodiment of the present invention.

FIGS. 10A, 10B, 100, 10D, 10E and 10F are schematic views illustrating a manufacturing process of the electron-emitting device according to an example of the present invention.

FIGS. 11A, 11B and 11C are schematic views of the electron-emitting device according to a comparative example of the present invention.

### DESCRIPTION OF THE EMBODIMENTS

An electron beam apparatus of the present invention has an electron-emitting device, which has a cathode, a gate and an insulating member, and an anode to which electrons emitted from the electron-emitting device are collided. Further, an image displaying apparatus of the present invention is composed of the above-described electron beam apparatus of the present invention and a light emitting member by arranging the light emitting member on the anode of the electron beam apparatus. Hereinafter, the electron beam apparatus and the image displaying apparatus according to the present invention will be described with reference to the exemplary embodiments.

### First Embodiment

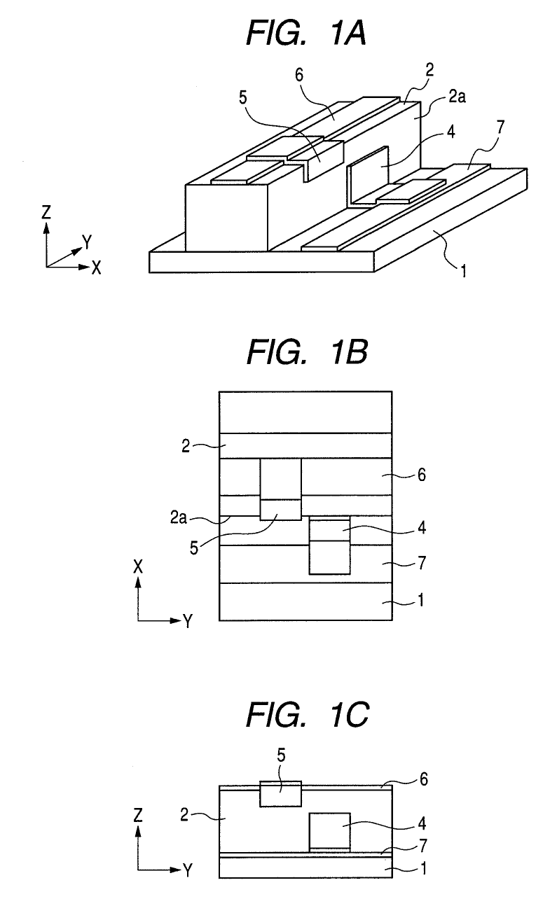

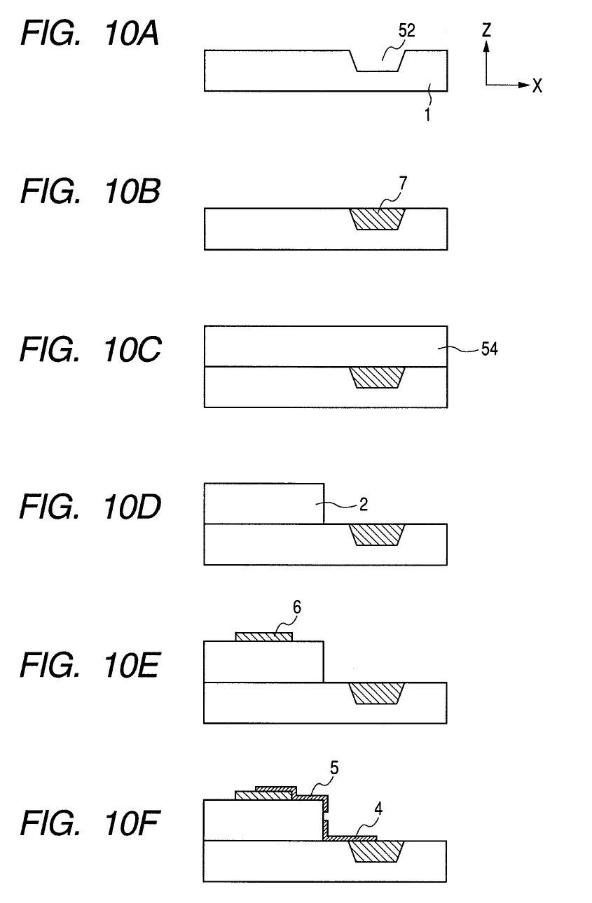

FIGS. 1A, 1B and 10 are schematic views illustrating the electron-emitting device of the electron beam apparatus according to an embodiment of the present invention. More specifically, FIG. 1A is a perspective view, FIG. 1B is a plan view (a diagram viewed from the Z direction), and FIG. 10 is a front view (a diagram viewed from the X direction). In the following description, it is assumed that, as a matter of convenience, a first direction in the present invention is the Y direction, a second direction in the present invention is the Z direction, and a direction perpendicular to both the first and second directions is the X direction. In FIGS. 1A, 1B and 10, an insulating substrate 1, an insulating member 2, a side surface 2a of the insulating member, a cathode 4, a gate 5, a feed line 6 to the gate and a feed line 7 to the cathode are illustrated.

The basic structure of the electron-emitting device according to the present invention consists of the insulating member 2, the cathode 4 and the gate 5, and the cathode 4 and the gate 5 are arranged on the surface 2a (in the present embodiment, a side surface) parallel to the Y direction and the Z direction of the insulating member 2. The cathode 4 and the gate 5 respectively have end sides parallel to the Y direction, and these end sides are arranged closely each other on the surface of the insulating member 2. Generally, the aforementioned device is formed on the insulating substrate 1. In the present example, the insulating substrate 1 has a surface (XY surface) parallel to the X direction and the Y direction, and the side surface 2a of the insulating member 2, on which the cathode 4 and the gate 5 are arranged, is perpendicular to the XY surface. However, it is not limited to this case in the present invention, and the side surface 2a may be formed in a state of inclining to a surface of the insulating substrate 1.

As the insulating substrate 1, it is arbitrarily selected from silica glass, glass from which a contained amount of impurity such as Na or the like is reduced, soda lime glass or a ceramics insulating member such as alumina. The insulating member 2 can be formed by performing a patterning process by using a photolithography method or the like after depositing the insulating material such as SiO₂, Si₃N₄ or the like on the substrate 1 by a general method such as a sputtering method or a CVD (Chemical Vapor Deposition) method. The insulating member 2 is formed so that the thickness (i.e., the height in the Z direction) of the insulating member 2 becomes within a range from 50 nm to 5 mm.

Although the cathode 4 and the gate 5 are formed on the side surface 2a of the insulating member 2, a general vacuum deposition technology such as a vapor deposition method, a sputtering method or the like and a photolithography technology or the like can be used for that purpose of forming the cathode 4 and the gate 5. As the materials of the gate 5 and the cathode 4, for example, metals such as Be, Mg, Ti, Zr, HF, V, Nb, Ta, Mo, W, Al, Cu, Ni, Cr, Au, Pt, Pd and the like, or alloy materials thereof and the carbides such as TiC, ZrC, HfC, TaC, SiC, WC and the like can be enumerated. In addition, the borides such as HfB₂, ZrB₂, CeB₇, Yb₅, GdB₅ and the like, the nitrides such as Tin, ZrN, HfN and the like, the semiconductors such as Si, Ge and the like or the organic polymer material can be also enumerated. Furthermore, the carbon and the carbon compound, in which amorphous carbon, graphite, diamond-like carbon and diamond are dispersed, are arbitrarily selected. The cathode 4 and the gate 5 may be formed by the same kind of material or may be formed by combining the different kinds of materials. The thickness of the gate 5 and the cathode 4 is set within a range from 5 nm to 5 μm, and more preferably, the thickness of the gate 5 and the cathode 4 are respectively selected from a range from 5 nm to 500 nm. In addition, the gate 5 and the cathode 4 are respectively connected with the feed line 6 and the feed line 7 laid out from the power supply. In the present example, the feed lines 6 and 7, the cathode 4 and the gate 5 may be formed at the same time.

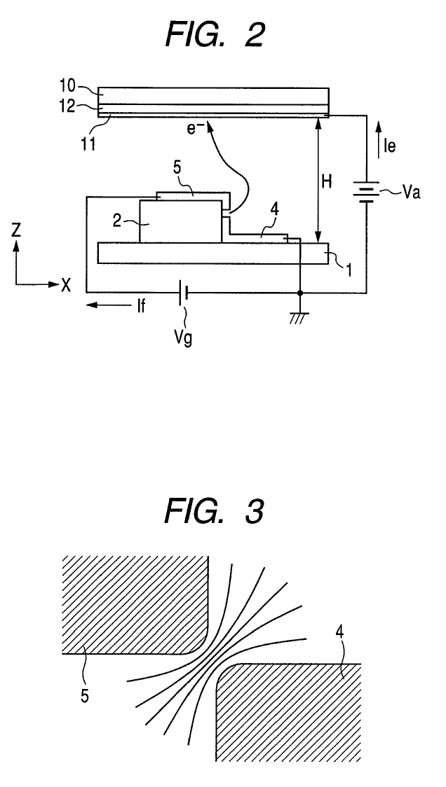

FIG. 2 is a view schematically illustrating the constitution of an image displaying apparatus, which used the electron beam apparatus of the present invention, and corresponds to a diagram viewed from the Y direction in FIGS. 1A to 1C. In FIG. 2, the feed line 6 and the feed line 7 illustrated in FIGS. 1A to 1C are omitted. And, a substrate 10, an anode 11 and a light emitting member 12 are illustrated in FIG. 2.

In the electron beam apparatus of the present invention, the anode 11 used for accelerating electrons emitted from the cathode 4 is arranged oppositely on a portion extended in the Z direction as illustrated in FIG. 2. In the present example, the anode 11 is arranged opposite to the substrate 1 separating from the substrate 1 having a distance H. In addition, the gate 5, which is on the side surface 2a of the insulating member 2 and has an end side parallel to the Y direction, is arranged between the anode 11 and the cathode 4. In the present invention, as illustrated in FIG. 2, the cathode 4, the gate 5 and the anode 11 are arranged in this order in the Z direction when viewing from the Y direction. As an image displaying apparatus of the present invention, the light emitting member 12, which emits the light due to the collision of electrons emitted from the electron-emitting device, is laminated on the anode 11 as illustrated in FIG. 2. In FIG. 2, reference symbol Vg denotes the voltage to be applied between the gate 5 and the cathode 4, reference symbol If denotes a device current which flows at this time when the voltage Vg is applied, reference symbol Va denotes the voltage to be applied between the cathode 4 and the anode 11 and reference symbol Ie denotes an electron-emitting current which flows from the electron-emitting device to the anode 11.

In the present invention, as apparent from FIGS. 1B and 1C, it is characterized in that an orthogonal projection of the gate 5 to the anode 11 is not overlapped with an orthogonal projection of the cathode 4. In other words, the cathode 4 and the gate 5, which are conventionally arranged opposite to the anode 11 in such a way that the orthogonal projections of the cathode 4 and the gate 5 to the anode 11 are overlapped with each other, are arranged with a state of displaced in the Y direction each other. Hereinafter, an effect in function according to this constitution will be described.

When driving the electron beam apparatus of the present invention, an electric field is induced on a surface of the cathode 4 by applying the voltage Vg between the gate 5 and the cathode 4. FIG. 3 is a schematic view of enlarging parts of the gate 5 and the cathode 4 of the electron-emitting device illustrated in FIG. 1C and schematically illustrating a state of equipotential lines when the voltage Vg was applied between the both electrodes. As illustrated in FIG. 3, density of the equipotential lines is highest at an adjacent point of the gate 5 and the cathode 4, and an electric field is concentrated on electrode end portions in the vicinity of the adjacent point. Here, when the field intensity on the surface of the cathode 4 exceeds a certain threshold, electrons are emitted from the surface of the cathode 4 due to a tunneling effect. Although the threshold of filed intensity needed to emit electrons is varied due to the condition such as the material of an electrode, a shape of the surface or the like, it is about such a value equal to or larger than 1×10⁹ V/m. In the electron-emitting device according to the present invention, since the field intensity becomes largest at an end portion of the cathode 4 in the vicinity of the gate 5 when the voltage Vg was applied between the gate 5 and the cathode 4, electrons are emitted from this end portion.

The electrons emitted from the end portion of the cathode 4 fly while being accelerated, and a part of the electrons directly collide with the anode 11 or a part of the electrons collide with a surface of the gate 5. Among the electrons which collided with the gate 5, although a part of those electrons are absorbed in the gate 5, the remained electrons are isotropically scattered by the surface of the gate 5. Among the scattered electrons, although a part of those electrons collide with the surface of the gate 5 again, another part of the electrons fly toward the anode 11 and reach the anode 11. The electrons which directly reached the anode 11 from the electron-emitting device or the electrons which reached the anode 11 after scattered at the gate 5 make the light emitting member to emit the light to be used to form an image, for example, in the image displaying apparatus as illustrated in FIG. 2.

Among the electrons emitted from the cathode 4, when a ratio of the electrons which reached the anode 11 given by an expression Ie/(If+Ie) is assumed as an electron emission efficiency η, this emission efficiency η significantly depends on the number of scattering at the gate 5. Although it is desirable that the electron emission efficiency η is in a higher level, for this purpose, it is desirable that the number of scattering is as less as possible. That is, when the electrons directly reach the anode 11 from the electron-emitting device, the emission efficiency η becomes the highest level, and when the electrons collide with the gate 5, it is desirable that the electrons reach the anode 11 by the scattering number which is as less as possible.

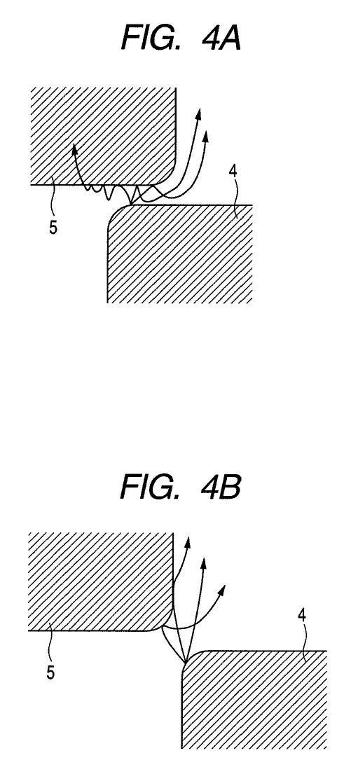

The number of scattering at the gate 5 is extremely changed depending on a position, where the electron flying from the cathode 4 is first scattered. Here, there will be described a cause of occurring difference in the number of scattering depending on a colliding position at the gate 5 with reference to FIGS. 4A and 4B. Similar to FIG. 3, FIGS. 4A and 4B are views (ZY plan views) viewed from the X direction which is the same as a case in FIG. 10. As illustrated in FIG. 4A, when the orthogonal projections of the cathode 4 and the gate 5 to the anode 11 are overlapped with each other, since the gate 5 exists in such a state of blocking an orbit of the electrons formed by the electric field, the electrons scattered at a lower surface of the gate 5 (a surface opposite to the cathode 4) tend to collide with the gate 5 many times. On the other hand, as illustrated in FIG. 4B, when the orthogonal projections of the cathode 4 and the gate 5 to the anode 11 are not overlapped with each other, since the electrons collided with a side surface of the gate 5 (a surface faced the Y direction) are accelerated toward the anode 11, the electrons tend to reach the anode 11 with the less number of scattering.

As described above, in order to improve the electron emission efficiency it becomes first important to increase electrons which directly reach the anode 11 without colliding with the gate 5, and it becomes second important to increase electrons which first collide with the side surface of the gate 5.

In the present invention, the constitution that the gate 5 does not exist between an electron-emitting position of the cathode 4 and the anode 11 by enabling to displace (offsetting) the gate 5 and the cathode 4 in the Y direction each other is adopted so that the orthogonal projections of the cathode 4 and the gate 5 to the anode 11 are not overlapped with each other. Therefore, the electrons which collide with the lower surface of the gate 5 are extremely decreased, and the electrons which directly reach the anode 11 without colliding with the gate 5 are increased. Due to this function, a significant improvement of the electron emission efficiency can be realized.

Since the number of electrons which directly reach the anode 11 is more increased when the offset amount between the gate 5 and the cathode 4 becomes larger, the electron emission efficiency is improved. However, when the distance between the gate 5 and the cathode 4 becomes longer, the voltage Vg used for obtaining the necessary field intensity becomes high voltage. Therefore, the aforementioned distance is arbitrarily selected according to the actual driving condition of the electron beam apparatus.

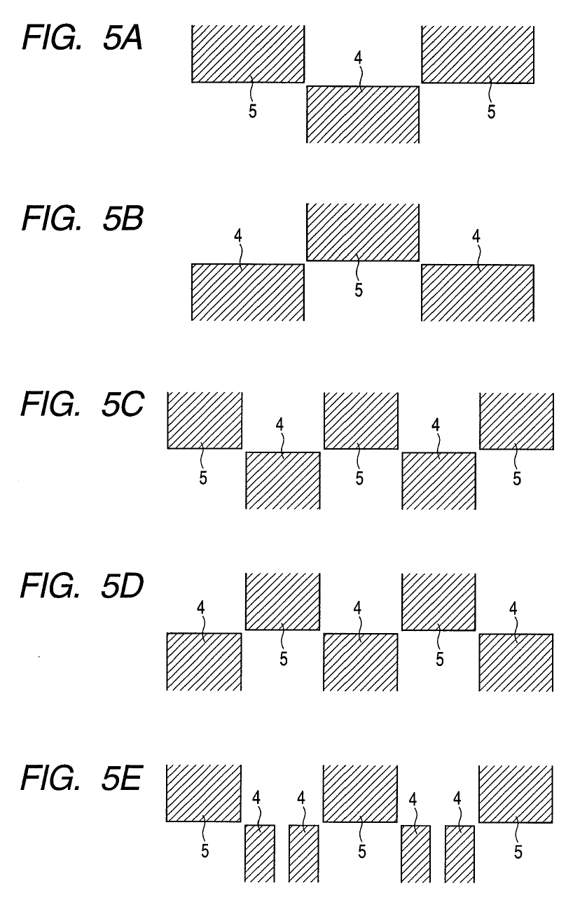

In the present invention, at least one piece of the gate 5 and one piece of the cathode 4 are respectively formed, however it is not always required that the same pairs of the gates 5 and the cathodes 4 are respectively formed. As illustrated in FIGS. 5A to 5E, there is also a case that the different numbers of the gates 5 and the cathodes 4 are formed. Note that FIGS. 5A to 5E are views (ZY plan views) viewed from the X direction which is the same as a case in FIG. 10. For example, as illustrated in FIG. 5A, one piece of the cathode 4 is arranged with such a state of interposed between two pieces of the gates 5. In an opposite manner, as illustrated in FIG. 5B, two pieces of the cathodes 4 may be arranged on both sides of the one piece of the gate 5. In the former case, since the both end portions of the cathode 4 can be utilized as electron-emitting devices, it is advantageous in a case that the electron-emitting devices are densely arranged. In the latter case, since a current amount per the cathode 4 can be suppressed, it is advantageous in a point of the durability of the electrode. Furthermore, as illustrated in FIGS. 5C to 5E, the electron-emitting devices may be formed by arranging arbitrary plural gates 5 and the cathodes 4 according to a combination of the arrangements in FIGS. 5A and 5B.

Although the shape of the gate 5 and the cathode according to the present invention is rectangle, an electrode may be separately interposed when the gate 5 and the cathode 4 connect with the feed line 6 and the feed line 7, and an overall shape formed by the electrode, the gate 5 and the cathode 4 is allowed not to become rectangle.

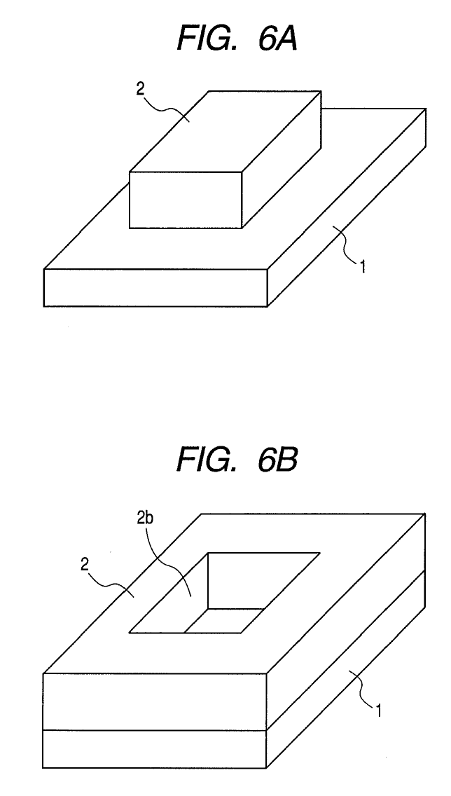

The gate 5 and the cathode 4 are formed on the side surface 2a of the insulating member 2 formed on the insulating substrate 1 as described above. The side surface 2a of this insulating member 2 can be formed by patterning an insulation film by use of the photolithography technology or the like after depositing the insulation film on the insulating substrate 1. In this case, the insulating member 2 may be remained as an island-like shape as illustrated in FIG. 6A, or a through-hole (recessed portion) 2b is formed in the insulating member 2 as illustrated in FIG. 6B, and an inner wall surface of the insulating member 2 may be utilized as the side surface 2a on which the cathode 4 and the gate 5 are to be arranged. A cross-sectional shape of the island-like portion or the recessed portion can form into various configurations such as square, circularity, star-shape, rectangle or oval. Furthermore, a region consisted of plural island-like portions or recessed portions may be formed by combining those various configurations and a wall surface only capable of forming the required numbers of the gates 5 and the cathodes 4 may be formed.

Furthermore, in the electron-emitting device, it is required to reduce the capacitance thereof in order to cope with a problem of, for example, realizing a high-frequency wave of a driver signal or the low-power consumption. On the other hand, in an image displaying apparatus in particular, a driving operation at the lower driving voltage is required in order to obtain a high contrast ratio. Therefore, in order to obtain the necessary field intensity under such the condition, the distance between the gate 5 and the cathode 4 has to be closer. As a result of this fact, such a problem of increasing the capacitance is remained.

Since the electron beam apparatus of the present invention adopts the structure that the gate 5 and the cathode 4 are displaced in the Y direction, the capacitance generated between the both electrodes can be extremely reduced, and a preferable effect can be realized at the same time for the two problems of improving the electron emission efficiency and reducing the capacitance.

### Second Embodiment

Next, the second embodiment of the present invention will be described.

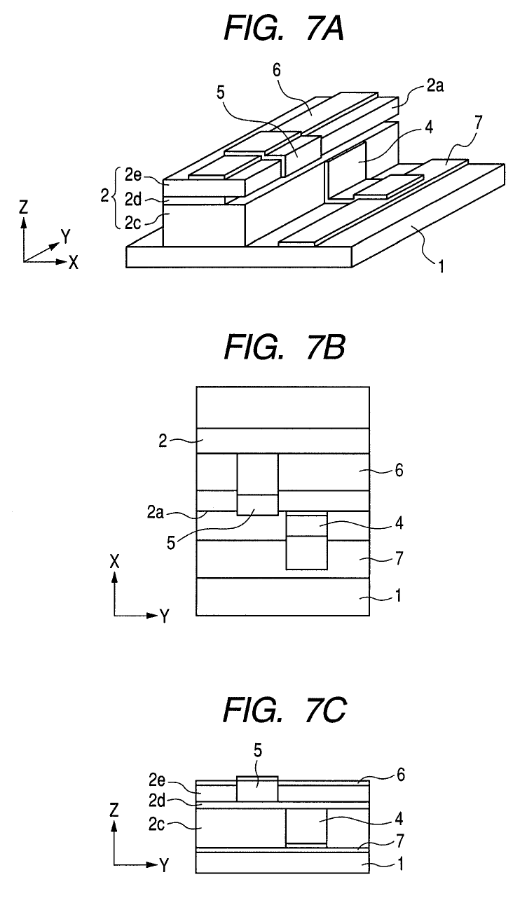

FIGS. 7A, 7B and 7C are views illustrating the structure of an electron-emitting device in the second embodiment. FIG. 7A is a perspective view, FIG. 7B is a plan view (a diagram viewed from the Z direction) and FIG. 7C is a front view (a diagram viewed from the X direction). In FIGS. 7A to 7C, insulating layers 2c, 2d and 2e are illustrated, and the same members as those in the apparatus in FIGS. 1A to 10 are denoted by the same reference numbers.

An apparatus of the present example has the same constitution as that of the apparatus in FIGS. 1A to 10 excepting a point that the insulating member 2 in FIGS. 1A to 10 has a recessed portion extending to the Y direction on the side surface 2a and an end side of the gate 5 parallel to the Y direction and an end side of the cathode 4 parallel to the Y direction are respectively arranged along edges oppositely positioned to the recessed portion. In the present example, since the recessed portion is formed on the insulating member 2, although the insulating member 2 adopts the 3-layer constitution formed by the insulating layers 2c, 2d and 2e, the present embodiment is not limited to this constitution, but the recessed portion may be formed on the insulating member 2 illustrated in FIGS. 1A to 1C.

The insulating layers 2C, 2d and 2e are formed by performing the general vacuum deposition method such as a sputtering method or the like, a CVD (Chemical Vapor Deposition) method, a vacuum vapor deposition method or the like to the insulating material such as SiO₂, Si₃N₄ or the like. The thickness of the insulating layer 2c is set within a range from 5 nm to 50 μm, and more preferably, the thickness is selected from such a range from 5 nm to 500 nm. The thickness of the insulating layer 2d is set within a range from 5 nm to 500 nm, and more preferably, the thickness is selected from such a range from 5 nm to 30 nm. The thickness of the insulating layer 2e is set within a range from 5 nm to 50 μm, and more preferably, the thickness is selected from such a range from 50 nm to 500 nm. Here, it is preferable that the insulating layer 2d is such the material capable of selectively performing the etching to the insulating layer 2C or the insulating layer 2e by a certain etchant. In addition, it is preferable that the insulating layer 2e is selected in consideration of selectivity at the time of performing the etching with the insulating layer 2d, and the insulating layer 2e may be formed by the same material as that of the insulating layer 2c. Incidentally, the layer 2e may be formed by a conductive material so that the member 2 also serves as a feed electrode to the gate electrode. A forming method of an insulating member 2 consisted of the aforementioned insulating layers 2c, 2d and 2e will be described.

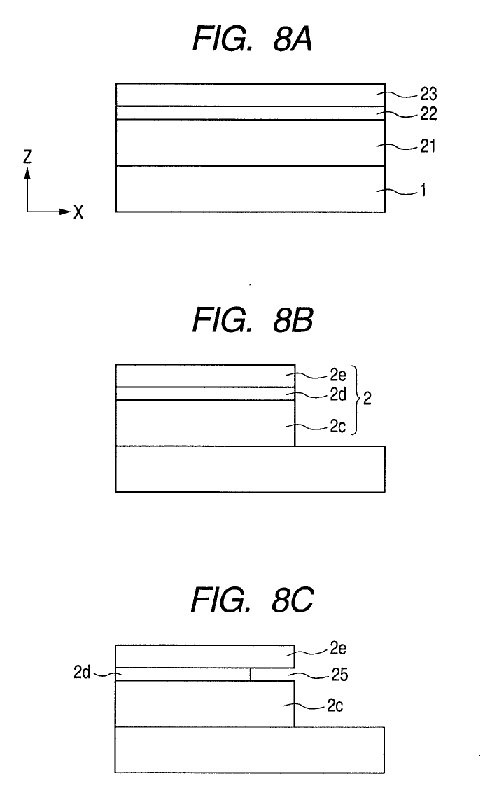

Insulation films 21 to 23 are sequentially deposited on an insulating substrate 1 by the general vacuum deposition method such as a sputtering method or the like, a CVD method, a vacuum vapor deposition method or the like (FIG. 8A), and the insulating member 2 having a side surface 2a is formed by patterning the laminated film by use of a photolithography technology or the like. In particular, for example, the spin coating of photoresist, the exposure and development of mask pattern are performed and then the laminated film of three layers is removed by the wet etching or the dry etching, thereby the insulating member 2 consisted of the insulating layers 2c, 2d and 2e is formed (FIG. 8B). In this etching process, it is preferable that a smooth etching surface is formed, and an etching method may be selected in accordance with the materials of respective layers. The insulating member 2 may be formed in such a way that the laminated film is remained as an island-like shape on the insulating substrate 1 or a through-hole is formed at the laminated film and an inner wall surface of the through-hole may be used.

Next, a side surface of the insulating layer 2d is set back by using the wet etching technology or the like so as to be in a position deeper set than positions of side surfaces of the insulating layers 2c and 2e and then a recessed portion 25 is formed (FIG. 8C).

As an etching method, for example, SiO₂ is selected as the material of the insulating layer 2c, PSG (Phosphoric Sodium silicate Glass: containing phosphoric acid 10%) is selected as the material of the insulating layer 2d and the SiO₂ is selected as the material of the insulating layer 2e similar to a case of the insulating layer 2c. In this case, when an etching process is performed by using a water solution obtained by diluted a liquid solution consisted of HF and NH₄F at a ratio of HF(48%):NH₄F(40%)=1:10 by a pure water to reach the concentration of 1% as an etchant, the insulating layer 2e is selectively etched, and only the side surface of the insulating layer 2d is set back to be resulted to form the recessed portion 25.

In addition, the similar configuration can be formed, for example, by selecting Si₃N₄ as the insulating layers 2c and 2e, selecting SiO₂ as the insulating layer 2d and also performing the etching by using a buffer hydrogen fluoride (BHF), and the materials of the respective layers and the etchant may be arbitrarily selected. The recessed portion 25 can be also formed in the course of the etching for forming the insulating member 2 at the same time.

After forming the recessed portion 25, the gate 5 and the cathode 4 are formed on the side surface 2a having the recessed portion 25. The gate 5 and the cathode 4 can be formed by performing the patterning by use of the photolithography technology or the like after depositing a conductive thin film by a method such as a sputtering method, a vapor deposition method or the like. At this time, in the electron beam apparatus of the present invention, the gate 5 and the cathode 4 are offset arranged so as not to be overlapped with each other when applying the orthogonal projections of the gate 5 and the cathode 4 to the anode 11, similar to a case in the first embodiment.

Here, in the electron beam apparatus of the present example, the gate 5 and the cathode are divided by a fact that the recessed portion 25 is formed. As a result, a micro gap serving as an electron-emitting device is automatically formed. The gate 5 and the cathode 4 are respectively connected with the feed line 6 and the feed line 7 laid out from the power supply, and a predetermined voltage is applied between the gate 5 and the cathode 4, thereby the high electrical field is generated at the gap and electrons are emitted from the cathode. As described above, the recessed portion 25 has not only a merit of automatically forming the gap which serves as the electron-emitting device but also has an effect of decreasing a leakage current which flows between the both electrodes when driving the electron beam apparatus and increasing the electron emission efficiency by lengthening a creepage distance between the gate 5 and the cathode 4.

As for the depth (length in the X direction) of the recessed portion 25, although it is desirable that a reduction effect of the leakage current becomes larger when the depth becomes deeper, on the other hand, if the depth becomes too deep, since there is the possibility of deforming or crumbling the insulating layer 2e at an upper portion of the recessed portion 25, the depth is arbitrarily set in consideration of the above-described problem.

Next, an image displaying apparatus which used the electron beam apparatus of the present invention will be described. As described above, the image displaying apparatus of the present invention is constituted by arranging the light emitting member on the anode of the electron beam apparatus of the present invention. In this case, plural electron-emitting devices according to the present invention are arranged on the substrate to serve as the electron source, and an image can be displayed by constituting plural pixels.

Generally, in the image displaying apparatus, plural electron-emitting devices are arranged in matrix in the X direction and the Y direction. And, the arrangement which is so-called a passive matrix arrangement, where the cathodes 4 or the gates 5 of the plural electron-emitting devices arranged on the same row are commonly connected with the X-directional wirings and the gates 5 or the cathodes 4 of the electron-emitting devices arranged on the same column are commonly connected with the Y-directional wirings, can be adopted.

In the electron-emitting device according to the present invention, electrons are emitted by applying the voltage equal to or larger than the threshold voltage between the gate 5 and the cathode 4. The amount of the electrons to be emitted is controlled by a peak value and the pulse width of the pulse voltage to be applied between the electrodes. On the other hand, since the electrons are not almost emitted under the voltage equal to or less than the threshold voltage, the necessary electron-emitting devices are selected by applying a pulse signal to the X-directional wirings and the Y-directional wirings, and the electron emission amount can be controlled.

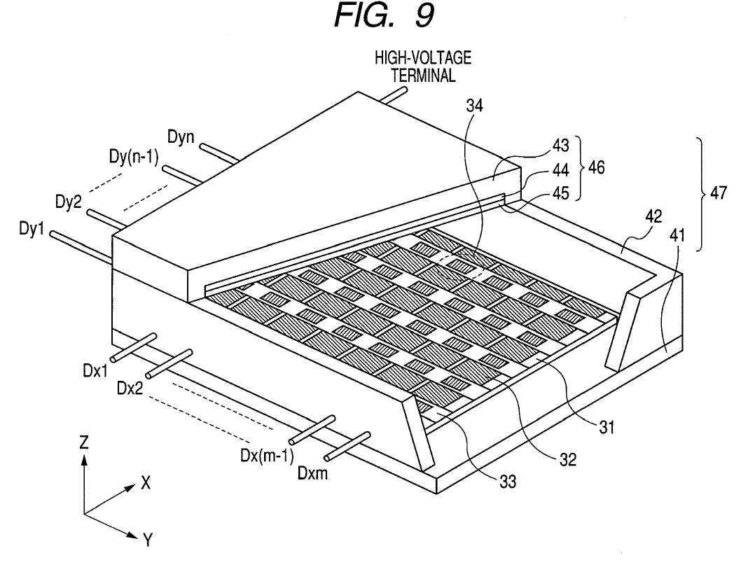

Next, the electron beam apparatus constituted by using the electron source of the passive matrix arrangement as described above will be described with reference to FIG. 9. FIG. 9 is a schematic view illustrating an example of a display panel of the image displaying apparatus which used the electron beam apparatus of the present invention. In FIG. 9, an electron source base 31 (corresponds to the substrate 1 in FIGS. 1A to 10) on which plural electron-emitting devices are arrange and a rear plate 41 to which the electron source base 31 is fixed are illustrated. A face plate 46 is composed of a glass substrate 43 (corresponds to the substrate 10 in FIG. 2), and a fluorescent film 44 serving as the light emitting member 12 and a metal back 45 serving as the anode 11 are formed at an inner surface of the glass substrate 43. The rear plate 41 and the face plate 46 are fixed with a support frame 42 by using the sealing member such as a frit glass or the like. An envelope 47 is constituted by performing a seal bonding process by baking it, for example, in the atmosphere or the nitrogen gas over ten minutes within the temperature range from 400° C. to 500° C. A device 34 corresponds to the electron-emitting device in FIGS. 1A to 1C. An X-directional wiring 32 and a Y-directional wiring 33 (corresponds to the feed line 6 and the feed line 7 in FIGS. 1A to 1C) are connected with the cathode 4 and the gate 5 of the electron-emitting device. The envelope 47 is constituted by the face plate 46, the support frame 42 and the rear plate 41 as described above. Since the rear plate 41 is provided for the purpose of mainly reinforcing the electron source base 31, in a case that the base 31 itself has the sufficient intensity, the support frame 42 is directly fixed with the base 31, and the envelope 47 may be constituted by the face plate 46, the support frame 42 and the base 31. Further, in accordance with necessity, the envelope 47 having the sufficient intensity for the atmospheric pressure can be constituted by setting a support member, which is not illustrated, called a spacer between the face plate 46 and the rear plate 41.

In the aforementioned display panel, the emitted electrons are accelerated and irradiated to the fluorescent material by supplying a scanning signal and a modulated signal respectively to the X-directional wiring 32 and the Y-directional wiring 33 and applying a high voltage to the metal back 45, thereby realizing to display an image.

Incidentally, the present invention is not limited to the above-described embodiments. Namely, the respective constituent elements of the present invention may be replaced with substitutes and/or equivalents if they achieve the object of the present invention.

Hereinafter, the present invention will be described in detail with reference to the following examples. Here, it should be noted that the present invention is not limited to these examples.

### Example 1

### Fabrication of Electron-Emitting Device

The rear plate 41 having the electron-emitting devices illustrated in FIGS. 1A to 1C was fabricated. The feed line 6 and the feed line 7 are respectively defined as a signal wiring and a scanning wiring, and the feed line 7 serving as the scanning wiring was set as an embedded wiring by forming a grove at the substrate 1. A fabricating process of the rear plate 41 in the present example was illustrated in FIGS. 10A to 10F. In FIGS. 10A to 10F, a groove 52 provided at the substrate 1 was illustrated in FIG. 10A and the same members as those in FIGS. 1A to 1C were denoted by the same reference numbers.

Initially, the groove 52 was formed at the substrate 1 by the wet-etching (FIG. 10A). Then, Cu was embedded in the groove 52 by a plating method and a substrate surface was formed to become smooth surface by the chemical mechanical polishing technology, thereby the scanning wiring 7 was formed (FIG. 10B). Next, a Si₃N₄ film was formed on the whole surface of the substrate as an insulating layer 54 so as to have the thickness of 500 nm by the sputtering method (FIG. 10C). Next, a resist pattern having an aperture at an area of the scanning wiring 7 was formed by exposing and developing the photoresist with used of a photo mask pattern by a photolithography process. The Si₃N₄ film on the scanning wiring 7 was removed by performing the etching to the Si₃N₄ film on the insulating layer 54 with a method of RIE (Reactive Ion Etching) by use of the CF₄-series gas by treating this resist pattern as a mask, thereby forming the insulating member 2 (FIG. 10D). Subsequently, a pattern used for a lift-off process was formed by the photoresist and then the patterning was performed by a lift-off method after depositing a Cu film by the sputtering method, thereby the signal wiring 6 was formed (FIG. 10E).

Ultimately, the gate 5 and the cathode 4 were formed and respectively connected with the signal wiring 6 and the scanning wiring 7 (FIG. 10F). In this process, initially, Mo having the thickness of 10 nm was selectively accumulated from the 45-degree obliquely upward by an EB (Electron Beam) oblique vapor deposition method. Next, resist patterns for the gate 5 and the cathode 4 were formed to have a comb-like shape by exposing and developing the photoresist with use of a photo mask pattern by the photolithography process. The comb teeth were formed at equal intervals of having the interval of 5 μm with a width of 5 μm in the Y direction, and a resist pattern for the gate and a resist pattern for the cathode were formed to become the nested structure viewing from the front direction. Thereafter, the Mo film was dry etched by using the CF₄ gas by treating the patterned photoresist as a mask and then the gate 5 and the cathode 4 were respectively processed into rectangle.

[Fabrication of Image Displaying Apparatus]

Plural electron-emitting devices were fabricated on the substrate according to the above-described fabrication process of the electron-emitting device, and an image displaying apparatus as illustrated in FIG. 9 was fabricated.

Initially, the face plate 46 was sealed and bonded with the substrate 41 via the support frame 42 at a position upward from the substrate 41 by 2 mm and the envelope 47 was formed. In addition, a spacer (not illustrated), of which the thickness is 2 mm and width is 200 μm, was arranged between the substrate 41 and the face plate 46 to have the structure of withstanding the atmospheric pressure. In the present example, two spacers were used. In addition, a getter (not illustrated) to be used to keep the inside of a container becomes the high vacuum was arranged in the envelope 47. The indium was used for bonding the substrate 41 and the face plate 46 with the support frame 42.

### Comparative Example 1

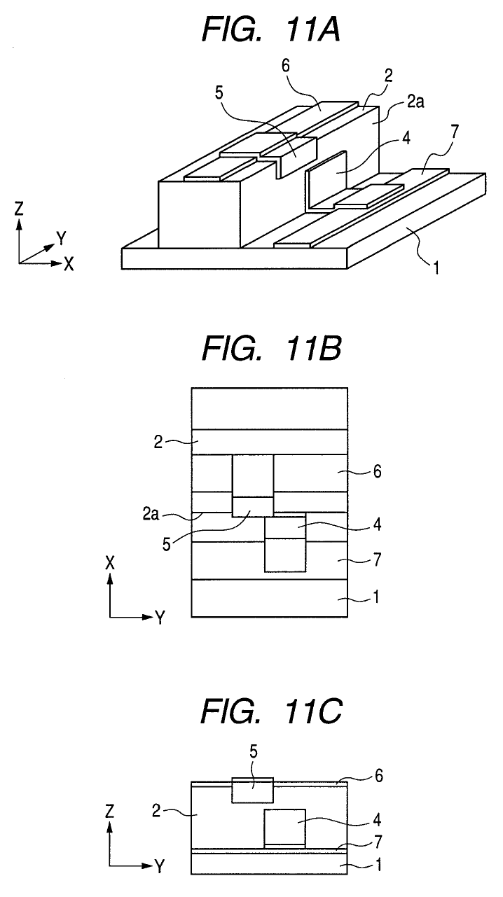

Next, as a comparative example, an image displaying apparatus having an electron-emitting device, of which the structure is illustrated in FIGS. 11A to 11C, was fabricated. In FIGS. 11A to 11C, FIG. 11A is a perspective view, FIG. 11B is a plan view (a diagram viewed from the Z direction) and FIG. 11C is a front view (a diagram viewed from the X direction). The constitution of the present example is the same as that in the Example 1 excepting a point that an orthogonal projection of the cathode 4 to the anode is partially overlapped with an orthogonal projection of the gate 5 to the anode. The gate was formed similar to a case in the Example 1, and an electron-emitting device, which was constituted that the width of the cathode in the Y direction is 6 μm and an overlapped area of the cathode and the gate is 0.5 μm, was fabricated and an image displaying apparatus was constituted. Since a fabrication method excepting the above description is the same as that in the Example 1, the description will be omitted.

(Evaluation Result)

In the image displaying apparatus fabricated as described above, the voltage was applied between the cathode 4 and the gate 5 through each of the wirings. Further, the voltage was applied to the metal back 45 of the face plate 46 through a high-voltage terminal and an image was displayed. At this time, the voltage from 0V to +10V was applied to the signal wiring (the Y-directional wiring 43), the voltage from 0V to −20V was applied to the scanning wiring (the X-directional wiring 42) and the voltage from 5 kV to 15 kV was applied to the metal back 45. Under this driving condition, the current If and the current Ie of the electron beam apparatuses in the Example and the Comparative Example 1 were measured and the electron emission efficiency Ie/If was calculated. The measurement was performed for 100 devices, and the mean values of the measured result were compared. In addition, the capacitance between the gate 5 and the cathode 4 was measured.

The current If of the electron-emitting device in the Example 1 becomes 210 μA per one device, that is, a value of the If did not almost change when comparing with the measured value in the Comparative Example 1. In contrast, a value of the Ie becomes 17 μA per one device in the Example 1, that is, this value becomes about two times of a measured value 8.4 μA in the Comparative Example 1, and it was confirmed that the electron emission efficiency reached a level of efficiency of about two times. Furthermore, in the electron-emitting device of the Example 1, the capacitance becomes 0.38 pF per one device, that is, this value becomes smaller by a rate of ten to twenty percents as compared with a measured value 0.44 pF in the Example 1. As a result, an effect of the present invention could be confirmed.

### Example 2

An image displaying apparatus was fabricated in a manner that the constitution of the electron-emitting device was similarly formed to that of the Example 1 excepting a point that the electron-emitting device was constituted to have the recessed portion illustrated in FIG. 7A. Incidentally, the insulating member 2 was fabricated by a process illustrated in FIGS. 8A to 8C.

A Si₃N₄ film of which the thickness is 500 nm, a SiO₂ film of which the thickness is 20 nm and Si₃N₄ film of which the thickness is 50 nm were sequentially accumulated as the insulating films 21, 22 and 23 on the substrate 1, on which the scanning wiring 7 was similarly formed to a case in the Example 1, by the sputtering method (FIG. 8A). Next, the photoresist was exposed and developed with use of a photo mask pattern by the photolithography process, and a resist pattern having an aperture for the exposure of an area of the scanning wiring 7 was formed. Thereafter, the insulating films 21, 22 and 23 were dry etched by use of the CF₄ gas by treating the patterned photoresist as a mask to be settled on the substrate 1, and the insulating member 2 was formed (FIG. 8B). Next, an etching process was performed to the insulating member 2 for eleven minutes by treating the BHF as an etching liquid, and a side surface of the insulating layer 2d was set back about 100 nm from the side surface 2a by selectively etched the insulating layer 2d, and the recessed portion 25 was formed (FIG. 8C). Thereafter, a process similar to that of the Example 1 was performed, and the electron-emitting device and even the image displaying apparatus were fabricated.

### Comparative Example 2

The electron-emitting device constituted similar to that of the Example 2 excepting a point that the width of the cathode 4 is 6 μm and the overlapped area of the cathode and the gate is 0.5 μm was fabricated similar to a case of the Comparative Example 1, and an image displaying apparatus was constituted.

(Evaluation Result)

In the image displaying apparatus constituted as described above, the apparatus was driven under the same driving condition as that of the Example 1, and the If and the Ie of the electron-emitting device were measured and then the electron emission efficiency Ie/If was calculated. The measurement was performed for 100 devices, and the mean values of the measured result were compared. In addition, the capacitance between the cathode 4 and the gate 5 was measured.

As a result, the current If of the electron-emitting device in the Example 2 became 210 μA per one device, that is, a value of the If did not almost change when comparing with the measured value in the Comparative Example 2. In contrast, a value of the Ie in the Example 2 became 21 μA per one device, that is, this value became about two times of a measured value 11 μA in the Comparative Example 2, and it was confirmed that the electron emission efficiency reached a level of efficiency of about two times. Furthermore, in the electron-emitting device of the Example 2, the capacitance became 0.34 pF per one device, that is, this value becomes smaller by a rate of ten to twenty percents as compared with a measured value 0.39 pF in the Example 2. As a result, an effect of the present invention could be confirmed.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2009-094716, filed Apr. 9, 2009, which is hereby incorporated by reference herein in their entirety.

What is claimed is:

1. An electron beam apparatus comprising:
an insulating member which has a surface being in parallel with a first direction and a second direction orthogonal to the first direction;
at least one rectangle-shaped cathode which is positioned on the surface of the insulating member and has an end side being in parallel with the first direction;
an anode which is positioned on an elongation in the second direction and arranged to be opposite to the end side of the cathode being in parallel with the first direction; and
at least one rectangle-shaped gate which is positioned on the surface of the insulating member and between the anode and the cathode, and has an end side being in parallel with the first direction,
wherein orthogonal projection of the gate to the anode does not overlap orthogonal projection of the cathode to the anode.

2. The electron beam apparatus according to claim 1, wherein
the insulating member has, on the surface thereof, a recessed portion extending in the first direction,
the end side of the gate being in parallel with the first direction and the end side of the cathode being in parallel with the first direction are arranged respectively along mutually opposite edges of the recessed portion.

3. An image displaying apparatus comprising:
an electrron beam apparatus as described in claim 1; and
a light-emitting member which is laminated and positioned on the anode.
